(19) United States
(12) Patent Application Publication
(10) Pub. No.: US 2023/0027774 A1
(43) Pub. Date: Jan. 26, 2023

(54) SMART REAL ESTATE EVALUATION SYSTEM

(71) Applicants: SinoPac Holdings Co., Ltd., Taipei City (TW); Bank Sinopac Company Limited, Taipei City (TW)

(72) Inventors: Tien-Hao Chang, Chiayi City (TW); Chin-Mei Chiang, New Taipei City (TW); Sheng-Wen Huang, Taipei City (TW); Shau-Wei Huang, New Taipei City (TW); Po-Yu Shen, Tainan City (TW); Li-Hao Zeng, Yilan County (TW)

(21) Appl. No.: 17/865,430

(22) Filed: Jul. 15, 2022

(30) Foreign Application Priority Data
Jul. 20, 2021 (TW) 110126627

(51) Int. Cl. G06Q 30/02; G06Q 50/16; G06N 5/00

(52) U.S. Cl. CPC G06Q 30/0206; G06Q 30/0283; G06Q 50/16; G06N 5/003

(57) ABSTRACT

To automatically evaluate the reasonable price of real estate according to the housing data, the present invention discloses a novel intelligent property evaluation system. The system includes the following components: a housing data input system, a pre-processing filter, a feature extractor, a housing price trainer, and a housing price predictor, wherein the housing price predictor further includes a regression model generator and a decision integrator. The pre-processing filter is used to filter unreasonable samples from housing data and integrate synonymous features. The feature extractor is used to choose required variables of housing price model. The housing price trainer generates housing price model which is trained by a great amount of housing data. The housing price predictor then generates a prediction by the trained model. Furthermore, to maintain the accuracy of prediction under the social evolution, the housing price predictor could be regularly or irregularly updated by a rolling-based method.

### CROSS-REFERENCE STATEMENT

The present application is based on, and claims priority from, Taiwan patent Application Serial Number 110126627, filed Jul. 20, 2021, the disclosure of which is hereby incorporated by reference herein in its entirety.

### TECHNICAL FIELD

The present invention relates to a real estate evaluation system, and more particularly, to an intelligent real estate evaluation system that predicts a reasonable housing price according to the housing data and the surroundings, and a model updates regularly or irregularly through rolling-based modeling.

### BACKGROUND

In current society, finance and business are developing rapidly, wherein the available assets owned by enterprises, organizations or individuals include various tangible properties and intangible properties. An important topic for developing finance and business is to estimate these assets objectively and reasonably to reflect the real value of enterprises and organizations. In terms of real estate, because it has the properties of immobility, durability, maintenance and increment, investment and self-use, various topics are derived in current society, such as residence justice, transaction transparency, unjustified investment of real estate.

Traditionally, three methods are often used in estimation of real estate, including market comparison method, cost method and income method. First, in the market comparison method, the alternative real estate is used as the comparison object to compare the transaction price, location, transportation, public construction, and the development trajectory of surrounding towns in the existing transaction cases. The premise of this method is to assume that similar houses will have similar prices in a fully competitive market. Second, based on the cost-of-production theory of value, the buyer and the seller will negotiate a reasonable range of housing price in the cost method. Since both buyer and seller expect to transact, a recognized range of price can be generated at the time of their transaction based on replacement cost. Finally, in the income method, the corresponding price of a real estate can be determined by the future income that can be brought to the owner. By estimating the annual income of the real estate in the future, and by selecting an appropriate income capitalization rate, the future income can be quantified, and a reasonable price range of the real estate can be calculated.

However, no matter which method is used, traditionally, the evaluation mainly depends on the experience of appraisers. In addition to taking substantial effort to collect data and estimate, the application field, calculation method and logical steps of the above three methods are also different due to the different perspectives of each appraiser. When estimating by manpower, there is often a large proportion of subjective judgment on the evaluation of real estate, which will also lead to a large difference in the price range of the evaluation. In view of the above deficiencies, the technology is now moving towards establishing a regression model for housing price prediction. For the purpose of estimating the real estate objectively, the model is used to regress and analyze huge amount of data to produce a specific function that represents the distribution of housing price.

In the above method of establishing the housing price prediction model, please refer to Taiwan patent No. I683321B filed by FIRST COMMERCIAL BANK. It uses the method of binary space segmentation and takes the geographical location or geographical range as the main variable to divide P geographical locations into Q geographical regions step by step by dichotomy. Whenever dichotomy cutting is carried out, it can generate new nodes in the classification coordinates and finally generate a binary tree. As querying or evaluating, you can check the binary tree and query which historical object the object to be evaluated is close to, so as to obtain the transaction price with similar building area, building type and housing age in the area.

In the above I683321B patent and other well-known technologies, taking geographical location, price, transportation, adjacent facilities, etc. as parameters of the housing price prediction model has been discussed. However, the application of practical technology in the past has rarely discussed the front-end data processing methods in such housing price prediction models. These methods include for example, how to deal with data with missing value, data with special remarks (such as transactions between relatives or friends), how to generate housing features with proper dimensions, or even how to deal with the environments of surroundings in different time (especially in financial, legal and commercial institutions, they will be more demanding on the problem of changing with time). Therefore, there is still room for improvement in the regression method of the existing housing price prediction model, so as to obtain more accurate evaluation results of real estate in a changing environment over time.

### SUMMARY

In order to solve the above problems, the invention proposes a smart real estate evaluation system, which includes the following architecture: an input system, which receives the input data from either website of actual price registration of real estate transaction owned by authority agency or other resources that provide housing data. A pre-processing filter is coupled with the input system to pre-process the input data, filter unreasonable data and integrate synonymous features. A feature extractor is coupled with the pre-processing filter, including a feature transformer which extracts and processes the features that are required to build the housing price model and predict the housing price, then these features are used to generate feature vectors for model training. A housing price trainer is coupled with the feature extractor to train a housing price model based on the feature vectors. A housing price predictor is used to predict the value of real estate based on the housing price model generated by the housing price trainer.

According to one aspect, the housing price predictor includes a decision integrator which is used to predict the value of real estate according to the operation result of a regression model.

According to another aspect, the regression algorithm of the regression model can be gradient boosting decision tree (GBDT), Catboost, XGBoost (eXtreme Gradient Boosting), LightGBM, etc. or a combination of the above algorithms.

According to one aspect, the smart real estate evaluation system includes a pre-processing filter, which is coupled with the input system and the feature extractor to deal with the housing data, and delete unreasonable or not applicable data, such as data with missing values (house age, building area, etc.) or special transactions (transactions between relatives). After pre-processing, the pre-processed data will become the input of the feature extractor.

According to one aspect, the housing price trainer is used to regress the feature vectors through the regression trees, and constructs the corresponding housing price model according to the types of housings, such as buildings, mansions, apartments and townhouse. The better number of features in the model ranges from 20 to 500.

In the invention, the housing price trainer generates multiple regression trees according to the feature vectors, that is, the housing price predictor integrates the decision results of the multiple regression trees to generate the final prediction. Because the decision-making methods of each regression tree are different, the housing price model can form a strong learner through integrating multiple weak learners to improve the accuracy of the housing price model in predicting the housing price.

The above description is used to explain the purpose, technical means and the achievable effect of the invention. Those familiar with the technology in the relevant field can understand the invention more clearly through the following embodiments, the accompanying description of the drawings and claims.

### BRIEF DESCRIPTION OF THE DRAWINGS

The components, characteristics and advantages of the present invention may be understood by the detailed descriptions of the preferred embodiments outlined in the specification and the drawings attached:

FIG. 1 shows a system architecture of a smart real estate evaluation system;

FIG. 2 shows a detailed content of a housing price predictor;

FIG. 3A illustrates some missing values in the process of data collection according to one embodiment;

FIG. 3B illustrates different data sources with different terms having the same meaning in the process of data collection according to one embodiment;

FIG. 4 shows some information included in the housing data, such as housing age, housing type, square meters, total housing price, adjacent facilities, etc;

FIG. 5 shows how the special housing price feature to be transformed into a high-dimensional housing price feature vector;

FIG. 6 illustrates a method of executing a smart real estate evaluation system.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The purpose of the invention is to improve performing processes of previous technology for predicting the selling price of objects in the housing price model. By improving the processes in the stages of housing data pre-processing, housing feature extraction and building housing price model and proposing the best applicable algorithm, it can improve generalizability and apply to various kinds of objects, such as apartments, buildings, townhouse, etc. The key points of improvements include as follows: first, in the stage of housing data pre-processing, the objects that missing data or exceed the reasonable range is screened; secondly, when extracting housing features, the appropriate data dimensions is analyzed and screened out according to the previous housing data; third, when building the housing price model, the housing price model can be continuously trained at a specific time interval, so that it can timely update and reflect social and economic changes, increase the accuracy of housing price prediction, and reduce the subjectivity of human analysis of housing prices.

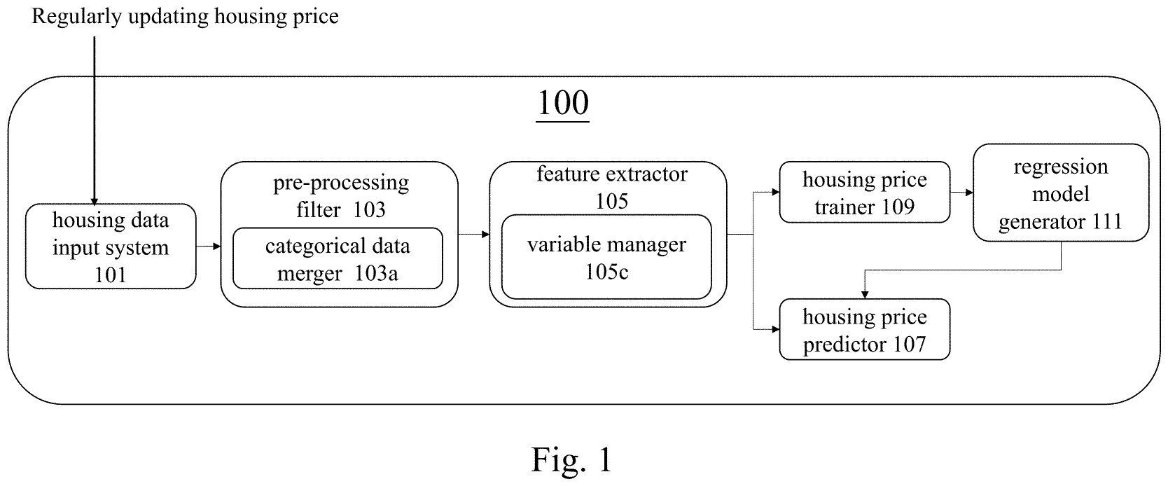

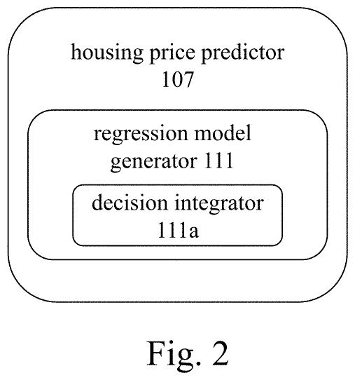

In order to achieve the above purpose, please refer to FIGS. 1-2. The invention proposes an intelligent (smart) real estate evaluation system 100 to train the housing price model through multiple housing data to evaluate the housing price of the objects that need to be traded at present. The system 100 is applied to various terminals having a processor (central processing unit, CPU), a microprocessor (micro control unit, MCU), a graphics processing unit (GPU), a memory, a temporary memory, a display, network communication modules, IO units, and operating systems, wherein the terminals include but not limited to smart phones, tablets, wearable devices, personal computers, workstations, etc. The system architecture of the intellectual real estate evaluation system 100 includes the following components and functions: a housing data input system 101 is used to regularly input housing data of multiple objects, such as housing age, housing size, type, adjacent facilities or selling price. A pre-processing filter 103 is coupled with the housing data input system to filter unreasonable data and integrate synonymous feature values. A feature extractor 105 is coupled with the housing data input system 101 and the pre-processing filter 103, including a variable manager 105c, which extracts and processes the housing data required to establish the housing price model and predict the housing price according to the needs of the application, and generates feature vectors through the selected variables. A housing price trainer 109 is coupled with the feature extractor 105 to train the housing price model through the generated feature vectors. A housing price predictor 107 is employed to predict the housing price of the object through the housing price model generated by the housing price trainer.

In an embodiment of the invention, when selecting variables, the variable manager 105c selects the corresponding fields (features or variables) in the housing data according to the needs of the application, such as room type, floor, housing size, etc. of the object, and the selection method is forward selection or/and backward selection. The forward selection method refers to select the significant (distinctive) housing features one by one into the model until all significant housing features are selected into the model. The backward selection method refers to eliminate the insignificant housing features one by one until all housing features stored in the model are significant. In addition, when the transaction is a multistorey building for sale, because a transaction involves (contains) multiple floors, the feature vectors need additional variable dimensions to describe this situation when training the housing price model. When the housing data includes parking spaces, it will also need to add an additional dimension of variables to indicate whether the housing data includes parking spaces, so as to improve the accuracy of the housing price model.

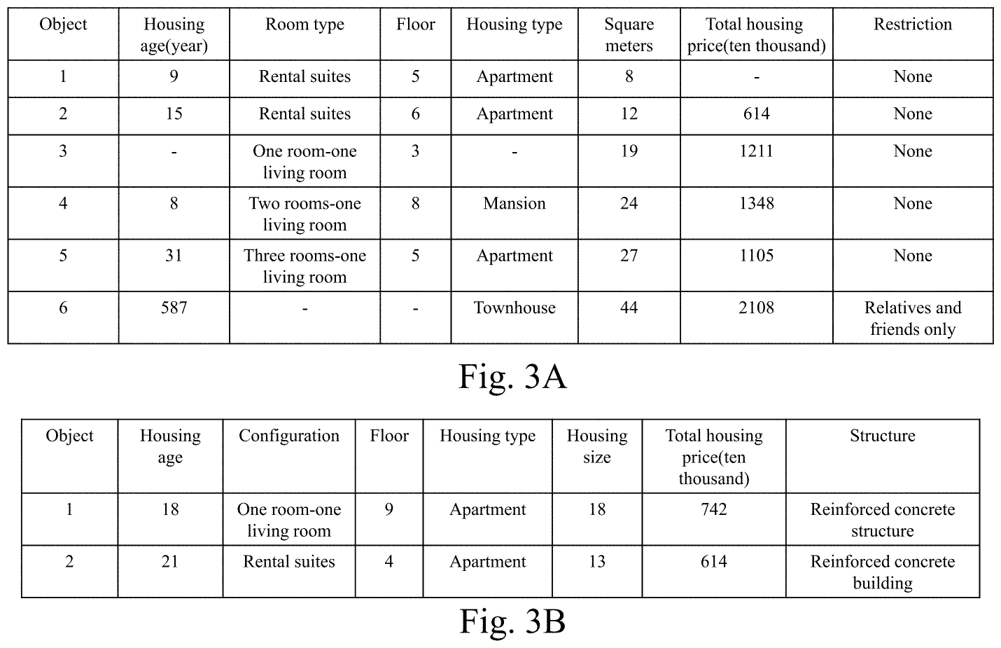

Referring to FIG. 3A, in an embodiment of the present invention, the intelligent real estate evaluation system 100 includes a pre-processing filter 103 for pre-processing housing data before the housing data is input into the housing price trainer 109 and the housing price predictor 107. When it receives the housing data input by the housing data input system 101, the pre-processing filter 103 first filters out the housing data that are obviously wrong, unreasonable, specially marked or unusable. For example, in FIG. 3A, there is no quotation in the total housing price of object 1, and object 3 lacks the information of housing age and type. In object 6, in addition to lack of the information of room type and floor, it is obviously unreasonable that its housing age is up to 587 years, and it is marked as transaction among relatives and friends, which is lower than the market price. The pre-processing filter 103 can remove the housing data with the above situation and not use it as training data of the housing price model, so as to avoid generating a housing price model that cannot represent the present situation of housing price.

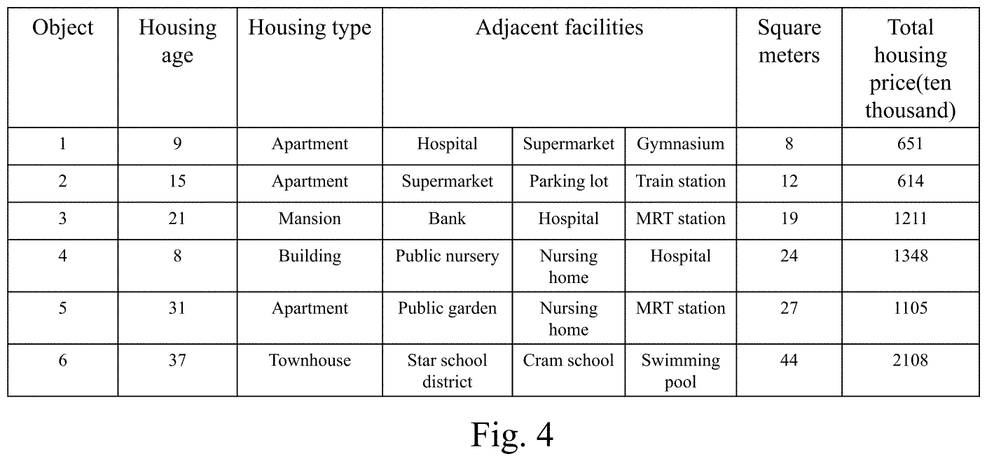

Referring to FIG. 1, FIG. 2, FIG. 3A, FIG. 3B and FIG. 4, according to an embodiment of the present invention, the pre-processing filter 103 includes a categorical data merger 103a. When the housing data is filtered by the pre-processing filter 103, the categorical data merger 103a merges the fields with similar properties in the housing data, such as housing age (year), room type and square meters in FIG. 3A, which are the same properties with housing age, configuration and housing size in FIG. 3B, respectively. In addition, when the content of each field has similar characteristic, such as the structure field of objects 1-2 in FIG. 3B, respectively records reinforced concrete structure and reinforced concrete building which have the same meaning. The categorical data merger 103a merges the above variable values into the same value so that the final feature vector can use the same variable to describe the same properties, to avoid the dimensional disaster caused by the unlimited generation of new variables by the variable manager 105c when the housing price model is established.

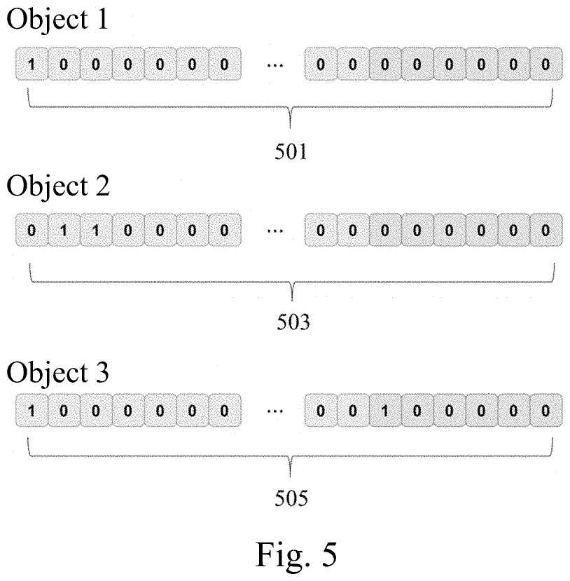

According to one embodiment of the invention, the housing price predictor 107 includes a regression model generator 111, which regresses housing price on feature vector through the regression tree. The regression algorithm of the regression model generator 111 can be gradient boosting decision tree (GBDT), Catboost, XGBoost (eXtreme Gradient Boosting), LightGBM, etc. or a combination of the above algorithms. The above feature vectors can be a high-dimensional matrix containing multiple variables (features or columns), and each object will correspond to its corresponding feature vector (rows). For example, when the transaction of an object involves the purchase and sale of multiple floors, such as the purchase of an apartment on two floors. Because each household has corresponding field values of room type, floor and area, it is difficult to express the variable in one dimension when trading multiple floors. Therefore, the multi-hot encoding technique is used to express this situation, referring to FIG. 5. In FIG. 5, object 1, object 2 and object 3 respectively correspond to the floor variables of three different objects. In the present invention, they are represented by the first feature vector 501, the second feature vector 503 and the third feature vector 505. For example, the trading floor of object 1 is the first floor, the trading floor of object 2 is the second and third floors, and so on. In addition, in an embodiment of the invention, the housing price predictor 107 includes a decision integrator 111a to predict the housing price of the object according to the result of regression operation of the regression model generator 111.

According to one embodiment of the invention, when the regression model generator 111 generates multiple regression trees according to the variables in the feature vector, each regression tree is equivalent to a weak learner. For example, take objects 1-4 in FIG. 4 as an example. If the housing age is taken as an example, it can make the first-order decision by taking the average age of 13.25 years, and distinguish objects 2 and 3 as above 13.25 years and objects 1 and 4 as below 13.25 years. Then, by taking the average age of 18 years of the objects 2 and 3 as threshold, the second-order decision separates object 2 and object 3. Each regression tree can continually make decisions on objects by the above method to establish a regression model. Finally, the decision integrator 111a integrates the results of the above multiple regression trees, so that the housing price model is created by multiple weak learners constituting a strong learner. In one embodiment of the invention, the model is built according to the type of building (such as mansion, building, apartment, townhouse), the address of county and city administrative district, etc., such as the building model of Da'an District, Taipei City, or the apartment model of Banqiao District, Xinbei City. The embodiment of the invention adopts a rolling-based modeling and updates the housing price model at intervals of T or from time to time to maintain the sensitivity to market. For example, the time interval T can be per month, just like the frequency of the actual price registration of real estate transaction updates. The number of variables used by the regression model generator 111 ranges from 20 to 500.

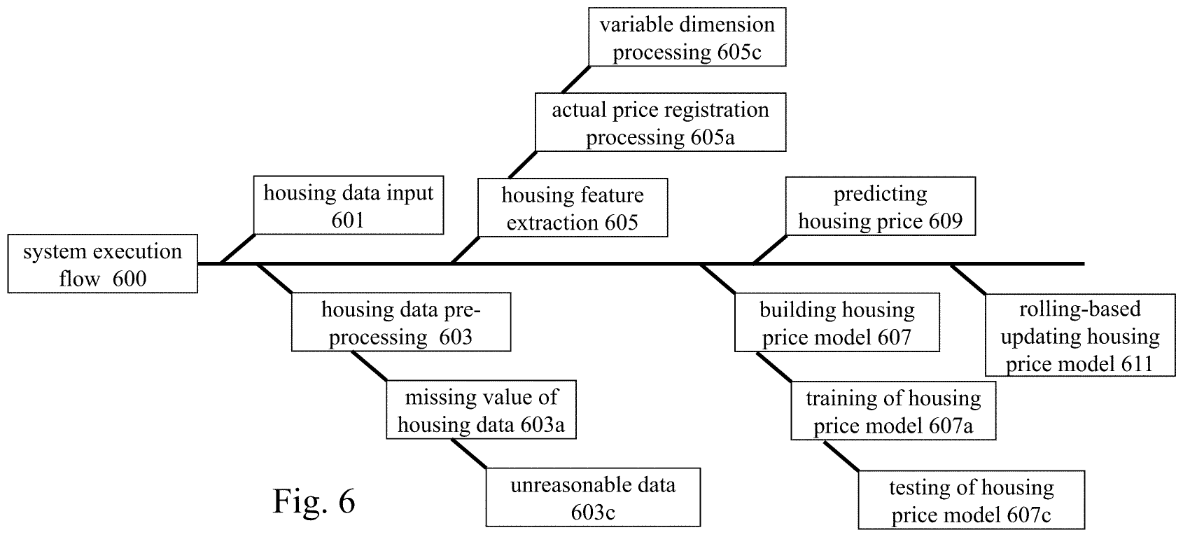

Referring to FIG. 6, it illustrates the system execution flow 600 of the intellectual (smart) real estate evaluation system 100 in one embodiment of the present invention. Firstly, during the training of housing price model, it is necessary to carry out the stage of housing data input 601, which inputs the housing data of multiple objects by the housing data input system 101. The input data source can be from a service network (website) providing data from the actual price registration of real estate transaction, or other resources that provide housing data. Then, after the housing data is entered, it must be transmitted to the pre-processing filter 103 for housing data pre-processing 603. In this stage, the pre-processing filter 103 will delete the obviously unusable data, such as those with missing value 603a or unreasonable data 603c. The former usually lacks representativeness because the housing data of the object is not complete. The latter is that housing data, such as the total housing price, square meters, floors and other data are obviously unreasonable, or the housing price is far higher or lower than the numerical range in a county or city administrative region.

Then, after the housing data pre-processing 603 stage is completed, it enters a housing feature extraction 605 stage. In this process, the feature extractor 105 extracts the features suitable for evaluating the housing price according to the housing data or the application scenarios of the transaction, such as housing age, housing type, adjacent facilities, housing size, etc., and ignore the less important factors according to the application needs, such as celebrity endorsement. In the stage of variable dimension processing 605c, the above features can be further selected by, for example, forward selection method or/and backward selection method. The variable manager 105c determines the number of features need to be used to generate feature vectors based-on the application scenarios, such as the computing resources of CPU and GPU, or the amount of information loss in the loss function.

Following by the above, when the feature vector is generated, it enters the house price modeling stage 607. In this process, the housing price trainer 109 and the housing price predictor 107 can generate a housing price model by an algorithm based on regression tree such as GDBT, Catboost, XGBoost (eXtreme Gradient Boosting), LightGBM or a combination of the above algorithms. Then, testing of housing price model 607c is performed on the test data, which is independent of the training data. If the generated housing price model can reach a certain accuracy in the test data, for example, the mean absolute percentage error (MAPE) is within 3%-10%, or the percentage of the absolute percentage error less than 10%, namely hit rate, is 60%-90%, the stage of building housing price model 607 is completed.

Subsequently, when the housing price model passes the test, the housing price predictor 107 predicts the housing price of the target object according to the housing price model. Finally, in the stage of rolling updating the housing price model 611, the housing data input system 101 inputs the latest housing data in the uncertain period or a fixed time interval T, and repeats the above steps to generate a new housing price model to meet the latest market trend. Meanwhile, it can also adjust the processing method in the feature extractor 105 according to the accuracy of the housing price model, such as the number of features, the feature vector, or the parameters of the algorithm in the housing price trainer 109.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A smart real estate evaluation system, comprising:
a housing data input system to regularly or irregularly input a plurality of housing data of multiple objects;
a feature extractor coupled with said housing data input system to extract plurality of housing data, wherein said feature extractor comprises a variable manager to manage dimensions of variables in said system and generates feature vectors from said plurality of housing data;
a housing price trainer coupled with said feature extractor to train a housing price model through said feature vectors; and
a housing price predictor to predict a housing price through said housing price model.

2. The system of claim 1, further comprising a pre-processing filter coupled with said housing data input system to filter unreasonable data and integrate synonymous features.

3. The system of claim 2, wherein said pre-processing filter includes a categorical data merger to merge fields with similar properties in said plurality of housing data.

4. The system of claim 1, wherein said housing price predictor includes a regression model generator to regresses variables in said feature vectors through regression trees.

5. The system of claim 4, wherein an algorithm of said regression model generator includes a gradient boosting decision tree (GBDT), Catboost, XGBoost (eXtreme Gradient Boosting), LightGBM or the combination thereof.

6. The system of claim 4, wherein said the housing price predictor includes a decision integrator to predict said housing price according to a result of regression operation of said regression model generator.

7. The system of claim 1, wherein said feature vectors are a high-dimensional matrix containing multiple variables, and each object corresponds to its corresponding feature vector.

8. The system of claim 1, wherein said regression model generator generates multiple regression trees according to variables in said feature vectors, each regression tree is equivalent to a weak learner.

9. The system of claim 8, wherein said decision integrator integrates results of said multiple regression trees so that said housing price model is created by multiple weak learners constituting a strong learner.

10. The system of claim 1, wherein said variable manager selects corresponding fields in plurality of housing data.

11. An executing method for smart real estate evaluation system, comprising:
inputting a plurality of housing data of multiple objects by a housing data input system;
transmitting said plurality of housing data to a pre-processing filter for housing data pre-processing;
extracting features suitable for evaluating a housing price based on said plurality housing data by a feature extractor;
generate a housing price model by a housing price trainer and a housing price predictor; and
predicting a housing price of a target object based on said housing price model by a housing price predictor.

12. The method of claim 11, wherein said plurality of housing data are from a service network of actual price registration of real estate transaction, or other resources that provide said plurality housing data.

13. The method of claim 11, further comprising a variable dimension processing, said features are selected by a forward selection method or a backward selection method by a variable manager to generate feature vectors.

14. The method of claim 13, wherein said housing price predictor includes a regression model generator to regresses variables in said feature vectors through regression trees.

15. The method of claim 14, wherein an algorithm of said regression model generator includes a gradient boosting decision tree (GBDT), Catboost, XGBoost (eXtreme Gradient Boosting), LightGBM or the combination thereof.

16. The method of claim 14, wherein said the housing price predictor includes a decision integrator to predict said housing price according to a result of regression operation of said regression model generator.

17. The method of claim 13, wherein said feature vectors are a high-dimensional matrix containing multiple variables, and each object corresponds to its corresponding feature vector.

18. The method of claim 14, wherein said regression model generator generates multiple regression trees according to variables in said feature vectors, each regression tree is equivalent to a weak learner.

19. The method of claim 18, wherein said decision integrator integrates results of said multiple regression trees so that said housing price model is created by multiple weak learners constituting a strong learner.

20. The method of claim 11, wherein said variable manager selects corresponding fields in plurality of housing data.
